(19) United States
(12) Patent Application Publication
(10) Pub. No.: US 2022/0083969 A1
(43) Pub. Date: Mar. 17, 2022

(54) DELIVERY RETURNS PROCESSING

(71) Applicant: International Business Machines Corporation, Armonk, NY (US)

(72) Inventors: Lisa Seacat DeLuca, Baltimore, MD (US); John Kaufmann, Austin, TX (US); Devin O'Bryan, Austin, TX (US)

(21) Appl. No.: 17/019,751

(22) Filed: Sep. 14, 2020

(51) Int. Cl. G06Q 10/08; G06Q 30/02

(52) U.S. Cl. CPC G06Q 10/0837; G06Q 30/0235; G06Q 10/0832

(57) ABSTRACT

Aspects of the present disclosure relate to returns processing for product deliveries. An order can be received for a product by a customer. A return policy specifying a limited time frame in which an immediate return of the product can be completed can be determined. The customer is then permitted to complete the immediate return of the product by providing the product to the deliverer within the limited time frame.

### BACKGROUND

The present disclosure relates generally to the field of delivery, and in particular, to delivery returns processing.

Delivery is the process of transporting goods from a source location to a destination. As developments in delivery are made, more options are available to customers, including same-day delivery, delivery tracking, and autonomous delivery (e.g., as completed by autonomous vehicles). Delivery of goods to customer is being adopted more frequently in industries such as clothing, food (groceries and restaurants), electronics, and others.

### SUMMARY

Embodiments of the present disclosure relate to a method, system, and computer program product for returns processing for product deliveries. An order can be received for a product by a customer. A return policy specifying a limited time frame in which an immediate return of the product can be completed can be determined. The customer is then permitted to complete the immediate return of the product by providing the product to the deliverer within the limited time frame.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating an example computing environment in which illustrative embodiments of the present disclosure can be implemented.

FIG. 2 is a block diagram illustrating an example computing environment in which illustrative embodiments of the present disclosure can be implemented.

FIG. 3 is a flow-diagram illustrating and example method for returns processing of a product, in accordance with embodiments of the present disclosure.

FIG. 4 is a diagram depicting an example immediate returns process for a product, in accordance embodiments of the present disclosure.

FIG. 5 is a diagram illustrating a cloud computing environment, in accordance with embodiments of the present disclosure.

FIG. 6 is a block diagram illustrating abstraction model layers, in accordance with embodiments of the present disclosure.

FIG. 7 is a high-level block diagram illustrating an example computer system that can be used in implementing one or more of the methods, tools, and modules, and any related functions described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of delivery, and more specifically, to delivery returns processing. While the present disclosure is not necessarily limited to such applications, various aspects of the disclosure can be appreciated through a discussion of various examples using this context.

Delivery is the process of transporting goods from a source location to a destination. As developments in delivery are made, more options are available to customers, including same-day delivery, delivery tracking, and autonomous delivery (e.g., as completed by autonomous cars and drones). Delivery of goods to customer is being adopted more frequently in industries such as clothing, food (groceries and restaurants), electronics, and others

Frequently, upon receiving an order, a customer will open their package and immediately know they will be returning the order. This can be due to the fact that the product has been damaged, does not fit, or does not match the product description they relied upon when ordering. Though many companies offer free returns in these instances, it can be difficult for customers to process the return. For example, the customer may be required to print a shipping label, arrange for a return on a company website, repackage the product, and mail the product back to the retailer. The returns process also negatively impacts the delivery provider. For example, the delivery provider typically covers the sunk cost of the return shipping. As such, there is a need to improve the returns process for customers and delivery providers alike.

Aspects of the present disclosure relate to returns processing for products. An order can be received for a product by a customer. A return policy specifying a limited time frame in which an immediate return of the product can be completed can be determined. The customer is then permitted to complete the immediate return of the product by providing the product to the deliverer within the limited time frame.

By allowing the customer to immediately complete the return, the burden of completing the returns process is lessened. For example, the customer can conveniently return the product within the packaging the product was included within without requiring the customer to mail the package back to the deliverer. Further, the cost to the deliverer is also lessened, as the cost for covering shipping for delayed returns is reduced. Overall, efficiency of the returns process is increased due to the immediate return of products to the deliverer.

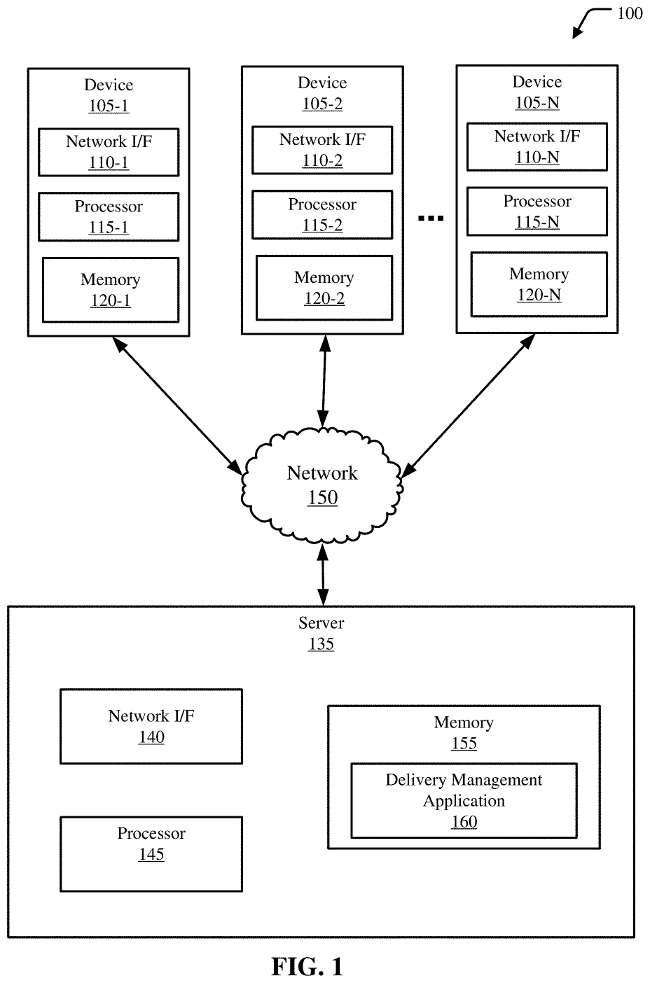

Turning now to the figures, FIG. 1 is a block diagram illustrating an example computing environment 100 in which illustrative embodiments of the present disclosure can be implemented. Computing environment 100 includes a plurality of devices 105-1, 105-2 . . . 105-N (collectively “devices 105”), at least one server 135, and a network 150.

Consistent with various embodiments, the server 135 and the devices 105 are computer systems (e.g., servers, desktops, laptops, or hand-held devices, etc.). The devices 105 and the server 135 include one or more processors 115-1, 115-2 . . . 115-N (collectively “processors 115”) and 145 and one or more memories 120-1, 120-2 . . . 120-N (collectively “memories 120”) and 155, respectively. The devices 105 and the server 135 can be configured to communicate with each other through internal or external network interfaces 110-1, 110-2 . . . 110-N (collectively “network interfaces 110”) and 140. The network interfaces 110 and 140 are, in some embodiments, modems or network interface cards. The devices 105 and/or the server 135 can be equipped with a display or monitor. Additionally, the devices 105 and/or the server 135 can include optional input devices (e.g., a keyboard, mouse, scanner, a biometric scanner, video camera, or other input device), and/or any commercially available or custom software (e.g., browser software, communications software, server software, natural language processing software, search engine and/or web crawling software, image processing software, biometric authentication software, etc.).

The devices 105 and the server 135 can be distant from each other and communicate over a network 150. In some embodiments, the server 135 can be a central hub from which devices 105 can establish a communication connection, such as in a client-server networking model. Alternatively, the server 135 and devices 105 can be configured in any other suitable networking relationship (e.g., in a peer-to-peer (P2P) configuration or using any other network topology).

In some embodiments, the network 150 can be implemented using any number of any suitable communications media. For example, the network 150 can be a wide area network (WAN), a local area network (LAN), an internet, or an intranet. In certain embodiments, the devices 105 and the server 135 can be local to each other and communicate via any appropriate local communication medium. For example, the devices 105 and the server 135 can communicate using a local area network (LAN), one or more hardwire connections, a wireless link or router, or an intranet. In some embodiments, the devices 105 and the server 135 can be communicatively coupled using a combination of one or more networks and/or one or more local connections. For example, the first device 105-1 can be hardwired to the server 135 (e.g., connected with an Ethernet cable) while the second device 105-2 can wirelessly communicate with the server 135 using the network 150 (e.g., over the Internet).

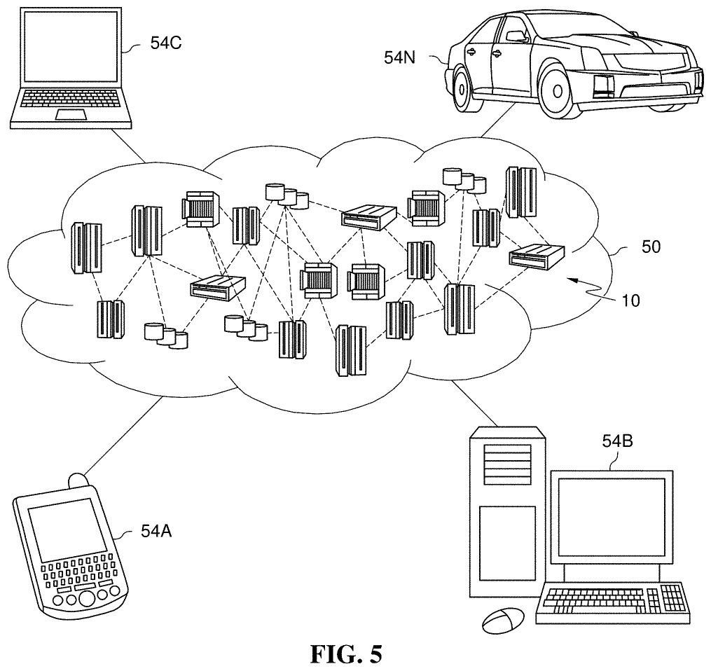

In some embodiments, the network 150 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 150. In some embodiments, the network 150 may be substantially similar to, or the same as, cloud computing environment 50 described in FIG. 5.

The server 135 includes a delivery management application 160. The delivery management application 160 can be configured to manage orders and returns associated therewith. In particular, the delivery management application 160 can be configured to receive an order for a product from a customer (e.g., from a customer device, such as device 105-1). The delivery management application 160 can be configured to provide updates to the customer regarding the delivery time frame (e.g., product “A” will arrive in 1 week). The delivery management application 160 can further be configured to determine a return policy for the customer. The return policy can be based on the delivery provider's return policy, a vendor's return policy, factors associated with the customer (e.g., previous return history, customer loyalty), and/or factors associated with the order (e.g., multiple of the same product in different sizes were ordered).

Upon delivering the product to the customer, the delivery management application 160 can be configured to manage the return process. In particular, the delivery management application 160 can be configured to prompt the customer (e.g., on a device of a courier or the customer) regarding the determined return policy. For example, the delivery management system 160 can notify the customer regarding: whether an immediate return is possible, the potential cost associated with the immediate return (e.g., cost per time for courier wait time, fixed wait time), the time frame that the immediate return is permitted (e.g., within 10 minutes), incentives for completing the immediate return (e.g., a discount on future orders), and a prompt option allowing the customer to accept or refuse the return policy.

As discussed herein, an “immediate return” refers to a return that is completed prior to the delivery service departing from the customer's delivery destination. As such, if an immediate return is completed, the customer returns one or more products to the delivery service (e.g., a courier or autonomous vehicle that is performing the delivery) prior to the delivery service departing from the destination of the initial delivery.

Upon receiving acceptance of the return policy, the delivery provider and customer are notified of the return policy by the delivery management application 160. Thereafter, the delivery management application 160 notifies the customer regarding the specific terms of the return policy. For example, the customer may be notified of the following: a limited time frame in which an immediate return is permitted, a cost associated with the immediate return, and/or incentives for performing the immediate return. Further, the customer can be provided an option (on their device) to notify the courier whether to leave or continue waiting for the return process. This process is referred to as a “confirmation” by the customer. For example, if the customer decides that the product they ordered is suitable after accepting the return policy, the customer can notify the deliverer that they can depart, thus ending the delivery (the customer confirms they want to keep the product). If the customer decides that the product they ordered is not suitable after accepting the return policy, the product can be accepted by the deliverer (e.g., a courier or autonomous vehicle performing the delivery) based on the terms of the return policy (the customer confirms they want to return the product). Thereafter, the product can be taken back to the merchant responsible for delivering the product and any return policy terms can be enforced (e.g., a cost of the immediate return can be billed to the customer and/or an incentive of the immediate return (e.g., a discount coupon) can be provided to the customer).

In embodiments, the delivery management application 160 can be configured to manage one or more autonomous vehicles (e.g., unmanned air vehicle (UAV) drones, self-driving cars, etc.) facilitating the delivery. For example, instead of a courier being notified of the return policy, the return policy can be provided to an autonomous vehicle performing the delivery. The autonomous vehicle can then abide by the terms of the return policy (e.g., waiting a predetermined time frame, accepting the return, and/or returning back to the merchant) as instructed by the delivery management application 160.

It is noted that FIG. 1 is intended to depict the representative major components of an example computing environment 100. In some embodiments, however, individual components can have greater or lesser complexity than as represented in FIG. 1, components other than or in addition to those shown in FIG. 1 can be present, and the number, type, and configuration of such components can vary. For example, in some embodiments, the delivery management application 160 can be distributed among multiple servers (not shown).

While FIG. 1 illustrates a computing environment 100 with a single server 135, suitable computing environments for implementing embodiments of this disclosure can include any number of servers. The various models, modules, systems, and components illustrated in FIG. 1 can exist, if at all, across a plurality of servers and devices. For example, some embodiments can include two servers. The two servers can be communicatively coupled using any suitable communications connection (e.g., using a WAN, a LAN, a wired connection, an intranet, or the Internet).

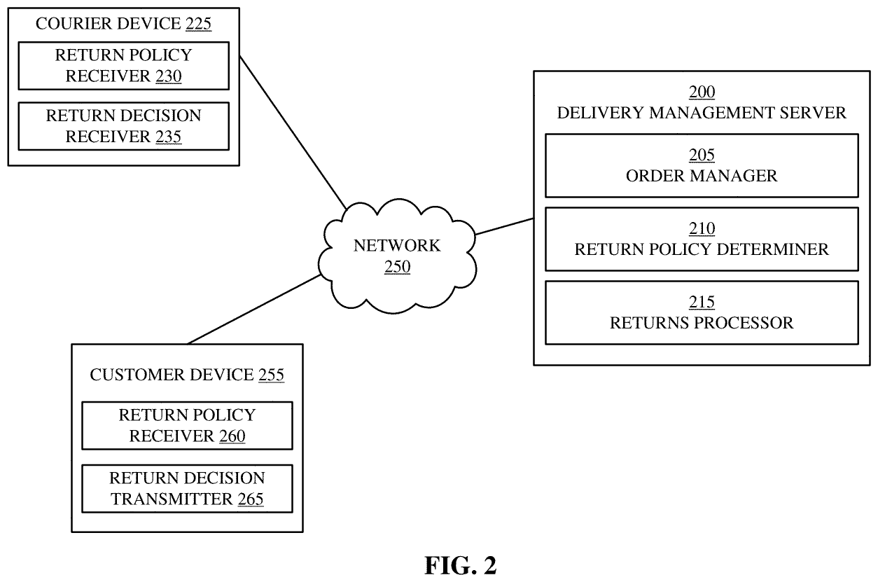

Turning now to FIG. 2, illustrated is a block diagram of an example computing environment in which illustrative embodiments of the present disclosure can be implemented. The computing environment includes a delivery management server 200 (e.g., server 135 of FIG. 1), a customer device 255 (e.g., device 105-1 of FIG. 1), and a courier device 225 (e.g., device 105-2 of FIG. 1) communicatively coupled via network 250 (e.g., network 150 of FIG. 1).

In embodiments, the delivery management server 200 can be a server, desktop computer, mobile device, or other device responsible for orchestrating deliveries and returns processing. The courier device 225 can be a mobile device carried by delivery personnel or alternatively an autonomous vehicle facilitating the delivery. The courier device 225 can be configured to provide a return policy to a customer and/or to receive a return decision from a customer. The customer device 255 can be a desktop computer, mobile device, or other device responsible for receiving a return policy and receiving a prompt allowing the customer to accept or deny the return policy.

The delivery management server 200 includes an order manager 205, a return policy determiner 210, and a returns processor 215. In embodiments, the order manager 205, return policy determiner 210, and returns processor 215 can be processor executable instructions that can be executed by a dedicated or shared processor using received inputs (e.g., from devices 225 and 255).

The order manager 205 is configured to manage orders received from customers (e.g., from customer device 255). The order manager 205 can be configured to receive orders, calculate invoices, track orders, and bill customers. In embodiments, the order manager 205 can be configured to archive completed orders such that customers can view their order history. In embodiments, order history can be used to aid in determining a return policy for the customer. Further, the order manager 205 can provide real-time updates on delivery windows for orders.

The return policy determiner 210 can be configured to determine a return policy for an order received by a customer. As discussed herein, a return policy refers to a set of terms/conditions required to facilitate a product return such that at least a portion of money used to complete an order can be returned to a customer in exchange for the product being returned back to the delivery service. In embodiments, the return policy varies for each order. That is, the return policy can be uniquely tailored based on factors associated with the customer, products ordered, and/or return reasons to be discussed further below.

The return policy can be determined in any suitable manner. In some embodiments, the return policy determiner 210 determines the return policy based at least in part on a predetermined return policy defined by an organization (e.g., of the delivery provider or a vendor). For example, the predetermined return policy defined by the organization can set terms such as: whether or not an immediate refund is allowed, the time window in which a return is permitted, the amount a customer is charged for a return, and discounts or incentives for completing returns. Thus, internal return policies of an organization can define at least a portion of terms within the determined return policy.

In some embodiments, the return policy determiner 210 determines the return policy based on factors associated with the customer (e.g., previous return history, customer loyalty, etc.). For example, the return policy can be determined based on a time frame since an individual has been a customer, the amount of transactions the customer has completed through the delivery service, the amount of money the customer has spent through the delivery service, and other factors. In embodiments, a more favorable return policy (e.g., a longer return window, more return incentives, less wait-time cost for processing an immediate return, etc.) can be set for customers that have been ordering over a longer time frame, making more orders over time, and spending more on orders over time, as an example. In embodiments, previous return history (e.g., a number of previously completed returns) can influence the return policy set for the customer. For example, if a customer has never made a return before, more favorable return policy terms can be set. As another example, if a customer frequently returns items within the allotted time window, the customer may be considered more reliable, and thus more favorable return policy terms can be set. However, the return policy can be determined based on factors associated with the customer in any suitable manner.

Thus, aspects of the present disclosure recognize that terms of a return policy such as: time frame in which an immediate return is allowed, cost (e.g., fixed or based on wait time) associated with processing a return, and incentives (e.g., discounts) for processing a return can be affected (e.g., increased or decreased) based on factors associated with a customer such as: customer loyalty (e.g., the time frame an individual has been a customer, the amount of orders the customer made, the amount of money a customer has spent on orders, etc.) and previous return history (e.g., the customer has not many any returns in the past, the customer has made returns but has complied with return policies, or the customer has not abided by previous return policies).

In embodiments, threshold values for customer loyalty (e.g., a threshold number of years the individual has been a customer, a threshold number of orders in the past, a threshold amount of money spent on orders) can be relied upon when determining whether to change policy terms as well as the magnitude of the changes applied to the terms.

In some embodiments, the terms of the return policy determined by the return policy determiner 210 are based on factors associated with the order placed by the customer. For example, if a customer orders multiple of the same product in different sizes, there may be a greater likelihood that an immediate return is going to be requested/accepted by a customer. As such, the return policy determiner 210 can set a longer time-frame (e.g., to try on the products of multiple sizes) to allow the customer to determine which size is appropriate. Other factors such as cost of processing an immediate return and/or incentives for completing the return can also be altered based on a number of identical/similar products ordered by a customer. As another example, the return policy can be determined based on the type of product ordered by the customer. For example, products such as clothing, jewelry, apparel (e.g., belts, wallets, hats, etc.), and home decor may have a higher likelihood of return due to the nature of the product (e.g., a greater requirement to be sized appropriately or aesthetically look a particular way “in person”). In these examples, the return policy can be more favorable to the customer as a return is more likely to be needed.

As such, aspects of the present disclosure recognize that terms of a return policy such as: time frame in which an immediate return is allowed, cost (e.g., fixed or based on wait time) associated with processing a return, and incentives (e.g., discounts) for processing a return can be affected (e.g., increased or decreased) based on characteristics associated with an order (e.g., a number of identical/similar products ordered in different sizes and/or a type of product). Thus, in response to receiving an indication of a product ordered in multiple sizes and/or a particular type of product being ordered, return policy terms such as time frame in which an immediate return is allowed, cost associated with processing a return, and incentives for processing a return can be altered (e.g., increased or decreased).

In some embodiments, the return policy can be based at least in part on a reason for the return. For example, a return policy for a return of a damaged product or an incorrectly described product (e.g., according to a product specification) can lead to more favorable return policy terms. For example, if the reason for return is a damaged product or incorrect product description, more time can be allotted for the return, less cost or no cost can be set as a term within the return policy, and/or incentives can be provided to the customer to aid with retaining the customer in the future. In embodiments, the claim that the product is damaged or incorrectly described can be verified (e.g., by the courier) prior to applying more favorable return terms.

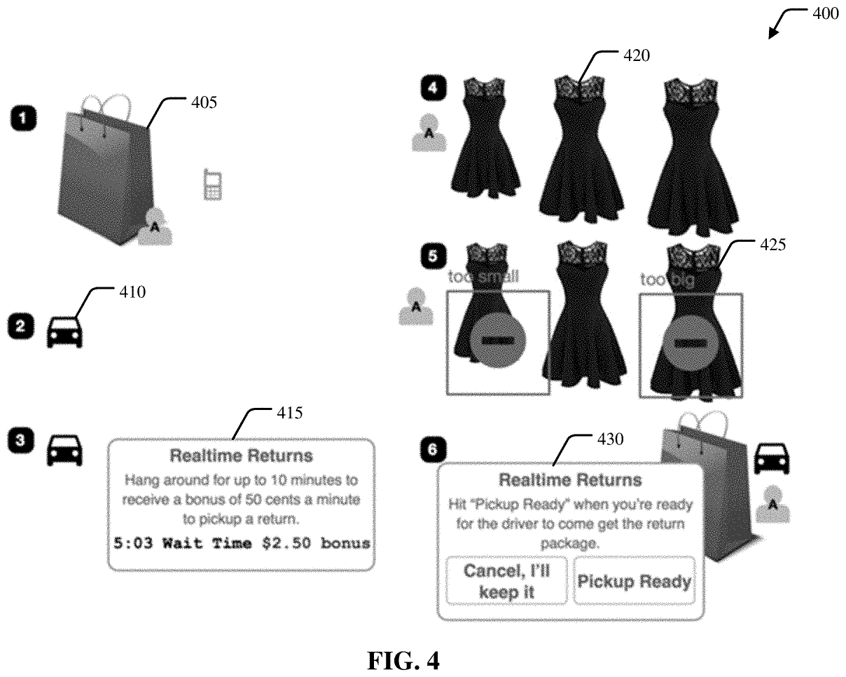

In some embodiments, the return policy can specify incentives or benefits for the deliverer. For example, the return policy can specify a bonus (e.g., per wait time) for deliverer to wait for the customer to determine whether they want to process an immediate return. An example deliverer incentive is depicted in FIG. 4.

Upon determining the return policy, the return policy determiner 210 can transmit the return policy to a return policy receiver 230 of the courier device 225 and/or a return policy receiver 260 of the customer device 255. This allows the customer of the customer device 255 to review the return policy to determine whether they want to accept the policy. If the customer accepts the return policy, they are subject to the terms set forth in the return policy. If the customer denies the return policy, then the deliverer can proceed to additional deliveries. A return decision transmitter 265 of the customer device 255 can be configured to transmit the return decision to a return decision receiver 235 of the courier device 225. Thus, upon the customer accepting or denying the return policy, the courier device 225 is informed and proceeds per the return policy (if accepted) or departs from the delivery destination (if denied).

The returns processor 215 of the delivery management server 200 then processes the return (if accepted) and executes the terms of the return policy. Thus, the returns processor 215 can be configured to bill the customer based on whether a cost applies to the immediate return (e.g., fixed or based on wait time) and/or provide incentives to the customer based on whether any incentives are set forth in the return policy. For example, if a customer accepted a return policy that charges $1 per minute wait-time and provides a 5% discount on a next order, assuming the customer took 5 minutes to provide the returned product, the returns processor 215 would bill the customer $5 and apply a 5% discount on the next order the customer places.

It is noted that FIG. 2 is intended to depict the representative major components of an example computing environment. In some embodiments, however, individual components can have greater or lesser complexity than as represented in FIG. 2, components other than or in addition to those shown in FIG. 2 can be present, and the number, type, and configuration of such components can vary. For example, although not shown in FIG. 2, in embodiments, there may not be a customer device 255 or courier device 225. In these embodiments, the customer can accept or deny the return policy via the courier device 225 or alternatively solely through the customer device 255, which may provide an indication directly to the delivery management server 200.

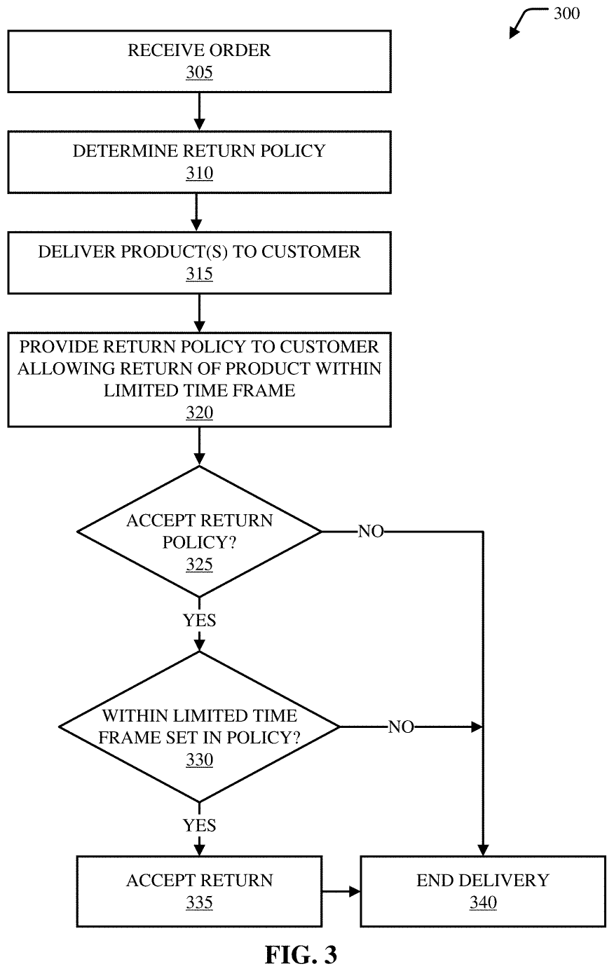

FIG. 3 is a flow diagram illustrating an example method 300 for returns processing, in accordance with embodiments of the present disclosure. The operations of FIG. 3 may be performed by one or more devices shown in FIGS. 1-2.

Method 300 initiates at operation 305, where an order is received. The order can be received via the Internet, mail, phone, or any other suitable communication. Any number of products may be included in the order. As such, a plurality of products can be delivered to the customer simultaneously based on the order.

A return policy is determined. This is illustrated at operation 310. The return policy can be determined in the same, or a substantially similar manner, as described with respect to the return policy determiner 210 of FIG. 2. Accordingly, the return policy can be determined based on one or more of: an organization's return policy, factors associated with the customer (e.g., customer loyalty and previous return history), factors associated with the order (e.g., multiple of the same/similar products of different sizes, the type of product, etc.), and/or reasons for the return (e.g., wrong product, damaged product, or incorrect product description). The return policy can specify terms such as: the time frame in which an immediate return is allowed, the cost for processing the immediate return, and incentives for performing the immediate return.

The product(s) ordered by the customer are then delivered to the customer. This is illustrated at operation 315. In embodiments, the delivery can be completed by a delivery personnel or an autonomous vehicle.

The determined return policy (at operation 310) is then provided to the customer (e.g., on a customer device) allowing return of the product within a limited time frame. This is illustrated at operation 320. The limited time frame can specify the time period in which the immediate return must be completed prior to the courier departing. For example, if the limited time frame is 10 minutes, the return would be required to be completed by the customer within 10 minutes before the courier is authorized to depart.

A determination is made whether the return policy is accepted by the customer. This is illustrated at operation 325. In embodiments, the return policy can be accepted or denied by the customer on a device associated with the customer or courier. For example, the customer can select an option on a graphical user interface (GUI) on their device accepting or denying the return policy. As another example, a customer can select an option on a GUI of an autonomous vehicle (or a courier personnel's mobile device) facilitating the delivery accepting or denying the return policy.

If a determination is made that the return policy is not accepted, then the delivery ends at operation 340. If a determination is made that the return policy is accepted, a determination is made whether the return is completed within the limited time frame set forth within the return policy. This is illustrated at operation 330. If the return is completed within the limited time frame set within the return policy, then the return is accepted. This is illustrated at operation 335. Upon accepting the return, terms within the return policy can be enforced and the delivery can end at operation 340.

The aforementioned operations can be completed in any order and are not limited to those described. Additionally, some, all, or none of the aforementioned operations can be completed, while still remaining within the spirit and scope of the present disclosure.

Referring now to FIG. 4, shown is a diagram illustrating an example process 400 for immediate returns processing, in accordance with embodiments of the present disclosure.

The process 400 initiates at operation 405, where an order is made by a customer. Upon receiving the order at operation 405, a delivery service delivers the products specified in the order to the customer at operation 410. The delivery service then receives a prompt for an immediate returns process. This is illustrated at operation 415. As shown in FIG. 4, the return policy can be voluntarily accepted by the delivery service. In this instance, the return policy can provide an incentive to the delivery service for performing the immediate return. As shown in FIG. 4, the return policy specifies that, if the delivery service waits up to 10 minutes, the delivery service will receive 50 cents per minute. As an example, as shown in FIG. 4, if the wait time is 5 minutes and 3 seconds, the delivery service provider would receive $2.50.

At operation 420, the customer, within the 10 minute window accepted by the delivery service, tries on multiple sizes of the product ordered at operation 405. The customer then selects a suitable size of the product. This is illustrated at operation 425. At operation 430, the customer initiates a confirmation process, in which the customer specifies whether they want to confirm the immediate return (e.g., facilitating the return of one or more products) or deny the immediate return. In this instance, as the customer found a suitable size at operation 425, the customer confirms the immediate return (e.g., on a GUI of a mobile device) indicating “Pickup Ready.” Thereafter, the delivery service can accept return of the products the customer wishes to return. However, if the customer desires to keep all products, the customer can deny the immediate return by selecting the option “Cancel, I'll keep it.”

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A (e.g., devices 105, 225, and 255), desktop computer 54B (e.g., server 135, delivery management server 200), laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

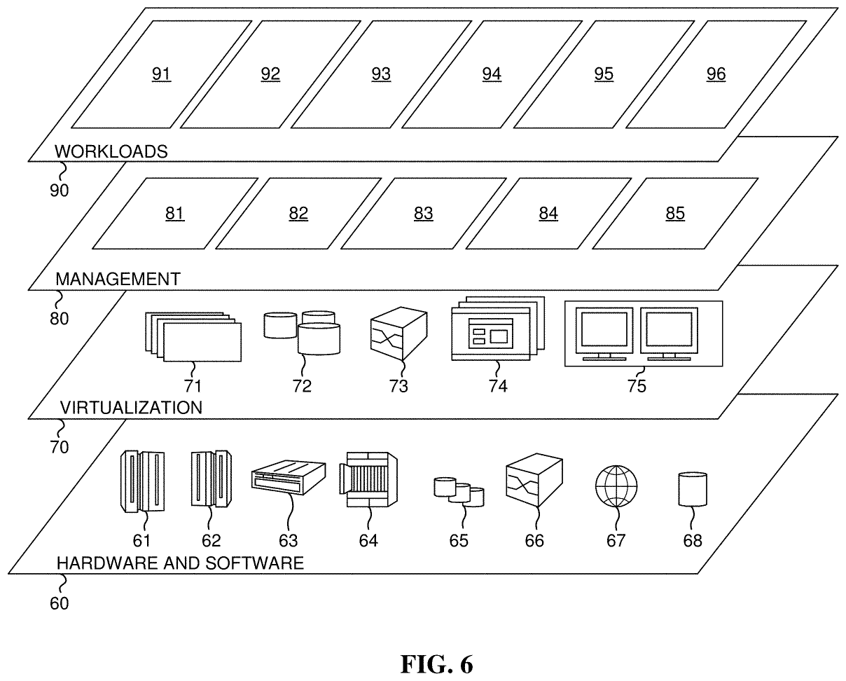

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and delivery management 96.

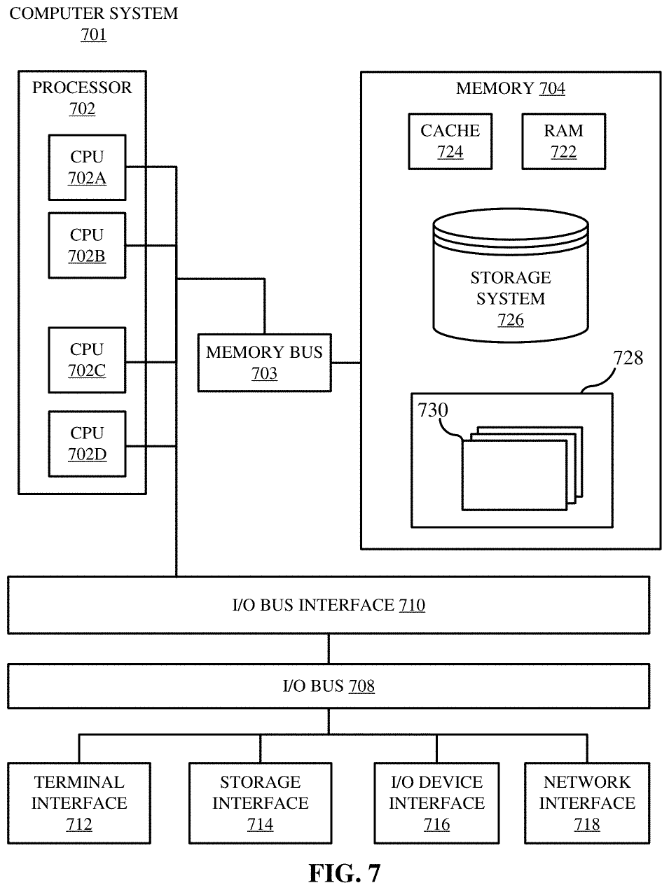

Referring now to FIG. 7, shown is a high-level block diagram of an example computer system 701 that may possibly be utilized in various devices discussed herein (e.g., devices 105, server 135, delivery management server 200, courier device 225, customer device 255) and that may be used in implementing one or more of the methods, tools, and modules, and any related functions, described herein (e.g., using one or more processor circuits or computer processors of the computer), in accordance with embodiments of the present disclosure. In some embodiments, the major components of the computer system 701 may comprise one or more CPUs 702 (also referred to as processors herein), a memory 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may include one or more levels of on-board cache.

Memory 704 may include computer system readable media in the form of volatile memory, such as random-access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730 may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 728 and/or program modules 730 generally perform the functions or methodologies of various embodiments.

Although the memory bus 703 is shown in FIG. 7 as a single bus structure providing a direct communication path among the CPUs 702, the memory 704, and the I/O bus interface 710, the memory bus 703 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used, and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method comprising:
receiving an order for a product by a customer;
determining a return policy specifying a limited time frame in which an immediate return of the product can be completed and a cost for performing the immediate return, wherein the cost for performing the immediate return is based on an amount of time elapsed within the limited time frame;
instructing an autonomous vehicle to deliver the product to the customer;
instructing the autonomous vehicle to present the return policy to the customer on a graphical user interface (GUI) to allow the customer to accept or reject the return policy;
receiving, on the GUI of the autonomous vehicle, acceptance of the return policy from the customer;
instructing the autonomous vehicle to wait the limited time frame in response to receiving the acceptance of the return policy;
instructing the autonomous vehicle to accept, within the limited time frame, the immediate return of the product; and
instructing the autonomous vehicle to collect the cost for performing the immediate return from the customer.

2-3. (canceled)

4. The method of claim 1, wherein the return policy further specifies an incentive associated with performing the immediate return.

5. The method of claim 1, wherein the return policy is based on a number of previous orders completed by the customer and a type of the product.

6-7. (canceled)

8. A system comprising:
a memory storing program instructions; and
a processor, wherein the processor is configured to execute the program instructions to perform a method comprising:
receiving an order for a product by a customer;
determining a return policy specifying a limited time frame in which an immediate return of the product can be completed and a cost for performing the immediate return, wherein the cost for performing the immediate return is based on an amount of time elapsed within the limited time frame;
instructing an autonomous vehicle to deliver the product to the customer;
instructing the autonomous vehicle to present the return policy to the customer on a graphical user interface (GUI) to allow the customer to accept or reject the return policy;
receiving, on the GUI of the autonomous vehicle, acceptance of the return policy from the customer;
instructing the autonomous vehicle to wait the limited time frame in response to receiving the acceptance of the return policy;
instructing the autonomous vehicle to accept, within the limited time frame, the immediate return of the product; and
instructing the autonomous vehicle to collect the cost for performing the immediate return from the customer.

9-11. (canceled)

12. The system of claim 8, wherein the return policy further specifies an incentive associated with performing the immediate return, the incentive being a discount on a future order for the customer.

13. The system of claim 8, wherein the return policy is based on a number of previous orders completed by the customer, wherein the limited time frame is increased based on the number of previous orders completed by the customer exceeding a threshold value.

14. The system of claim 8, wherein the return policy is based on a type of the product, wherein the limited time frame is increased based on the type of product matching a particular product type.

15. A computer program product comprising a computer readable storage medium having program instructions embodied therewith, the program instructions executable by a processor to cause the processor to perform a method comprising:
receiving an order for a product by a customer;
determining a return policy specifying a limited time frame in which an immediate return of the product can be completed and a cost for performing the immediate return, wherein the cost for performing the immediate return is based on an amount of time elapsed within the limited time frame;
instructing an autonomous vehicle to deliver the product to the customer;
instructing the autonomous vehicle to present the return policy to the customer on a graphical user interface (GUI) to allow the customer to accept or reject the return policy;
receiving, on the GUI of the autonomous vehicle, acceptance of the return policy from the customer;
instructing the autonomous vehicle to wait the limited time frame in response to receiving the acceptance of the return policy;
instructing the autonomous vehicle to accept, within the limited time frame, the immediate return of the product; and
instructing the autonomous vehicle to collect the cost for performing the immediate return from the customer.

16-17. (canceled)

18. The computer program product of claim 15, wherein the return policy is based on the product being ordered in multiple sizes, wherein the limited time frame is increased based on the product being ordered in multiple sizes.

19. The computer program product of claim 15, wherein a fixed-cost for performing the immediate return is set as a term within the return policy based on the product being ordered in multiple sizes.

20. The computer program product of claim 15, wherein a discount for performing the immediate return is set as a term within the return policy based on the product being ordered in multiple sizes.
